(19) United States
(12) Patent Application Publication
(10) Pub. No.: US 2023/0152437 A1
(43) Pub. Date: May 18, 2023

(54) RADAR APPARATUS

(71) Applicant: Mitsubishi Electric Corporation, Tokyo (JP)

(72) Inventor: Koichi KAI, Tokyo (JP)

(73) Assignee: Mitsubishi Electric Corporation, Tokyo (JP)

(21) Appl. No.: 17/920,624

(22) PCT Filed: May 25, 2020
(86) PCT No.: PCT/JP2020/020471

§ 371 Date: Oct. 21, 2022

(51) Int. Cl. G01S 13/58; G01S 13/931; G01S 7/35

(52) U.S. Cl. CPC G01S 13/584; G01S 13/931; G01S 7/352; G01S 2013/932; G01S 7/356

(57) ABSTRACT

To provide a radar apparatus which can prevent occurrence of two or more of calculated values of the actual relative speeds by round of combination, and determine the actual relative speed uniquely, when calculating the actual relative speed without folding by combining the relative speeds detected by the frequency modulation signal of each kind among plural kinds. A radar apparatus (1) sets a speed width (ΔVr) of the speed calculation range to less than a speed width that the actual relative speed can be calculated uniquely; and calculates an actual relative speed (Vr) which does not have folding due to a detection range of relative speed, within the speed calculation range.

To provide a radar apparatus which can prevent occurrence of two or more of calculated values of the actual relative speeds by round of combination, and determine the actual relative speed uniquely, when calculating the actual relative speed without folding by combining the relative speeds detected by the frequency modulation signal of each kind among plural kinds. A radar apparatus sets a speed width of the speed calculation range to less than a speed width that the actual relative speed can be calculated uniquely; and calculates an actual relative speed which does not have folding due to a detection range of relative speed, within the speed calculation range.

### TECHNICAL FIELD

The present disclosure relates to a radar apparatus.

### BACKGROUND ART

There has been known the radar apparatus of FCM (Fast Chirp Modulation) method which detects the distance and the relative speed of the detection object by using the chirp signal whose frequency increases or decreases continuously as the radar wave, and performing frequency analysis twice to the beat signal generated from the transmission signal and the reception signal. For example, refer to patent documents 1 to 3.

For example, in the technology of patent document 2, in order to solve the folding of the relative speed, two kinds of chirp signals whose detection ranges of relative speed are different with each other are transmitted; the distance and the relative speed of each detection object are calculated by performing frequency analysis about the chirp signal of each kind; and the relative speed without folding is calculated by combining the relative speeds of the detection objects among the different kinds of chirp signals.

For example, if the radar apparatus is mounted in the vehicle, the relative speed of moving object, such as the vehicle which exists in front of the own vehicle, and the relative speed of the static object, such as the roadside object of road and the building, are detected.

### CITATION LIST

### Patent Literature

Patent document 1: U.S. Pat. No. 7,639,171 B
Patent document 2: JP 2017-58291 A
Patent document 3: JP 2017-90066 A

### SUMMARY OF INVENTION

### Technical Problem

However, even if it is configured to calculate the actual relative speed without folding by combining the relative speeds detected by the frequency modulation signal of each kind among plural kinds, if the speed calculation range of the actual relative speed is set wide, combination takes a round, two or more of the calculated values of the actual relative speeds occur, and the actual relative speed cannot be decided uniquely.

Then, the purpose of the present disclosure is to provide a radar apparatus which can prevent occurrence of two or more of calculated values of the actual relative speeds by round of combination, and determine the actual relative speed uniquely, when calculating the actual relative speed without folding by combining the relative speeds detected by the frequency modulation signal of each kind among plural kinds.

### Solution to Problem

A radar apparatus according to the present disclosure including:

a transmission unit that transmits plural kinds of frequency modulation signals whose detection ranges of relative speed are different with each other, from a transmission antenna;

a reception unit that receives the plural kinds of frequency modulation signals reflected by one or a plurality of objects, by a reception antenna, and mixes the transmitted frequency modulation signal and the received frequency modulation signal and generates a beat signal, about each kind of the frequency modulation signal;

a frequency analysis unit that performs a frequency analysis of the beat signal about each kind of the frequency modulation signal, and calculates a distance and a temporary relative speed with respect to an own apparatus about each of the object;

a speed range setting unit that sets a speed calculation range; and

a relative speed calculation unit that combines the distance and the temporary relative speed of the object among different kinds of the frequency modulation signals, respectively, and calculates an actual relative speed which does not have folding due to a detection range of the relative speed, within the speed calculation range, about the each object,

wherein the speed range setting unit sets a speed width of the speed calculation range to less than a speed width that the actual relative speed can be calculated uniquely.

### Advantage of Invention

According to the radar apparatus of the present disclosure, since the speed calculation range is set to less than a speed width that the actual relative speed can be calculated uniquely, two or more of the actual relative speeds corresponding to combination can be prevented from being calculated, and the actual relative speed can be calculated uniquely.

### BRIEF DESCRIPTION OF THE DRAWINGS

FIG. 1 is a schematic configuration diagram of the radar apparatus according to Embodiment 1;

FIG. 2 is a time chart explaining the transmission signal, the reception signal, and the beat signal according to Embodiment 1;

FIG. 3 is a hardware configuration diagram of the controller according to Embodiment 1;

FIG. 4 is a flowchart for explaining the processing of the radar apparatus according to Embodiment 1;

FIG. 5 is a figure for explaining the first frequency analysis result according to Embodiment 1;

FIG. 6 is a figure for explaining the second frequency analysis result according to Embodiment 1;

FIG. 7 is a figure for explaining the folding of the temporary relative speed according to Embodiment 1;

FIG. 8 is a figure for explaining the round of combination according to Embodiment 1;

FIG. 9 is a figure for explaining the round of combination according to Embodiment 1;

FIG. 10 is a figure for explaining setting of the speed calculation range according to the speed of own apparatus according to Embodiment 1;

FIG. 11 is a schematic configuration diagram of the radar apparatus according to Embodiment 2;

FIG. 12 is a flowchart for explaining setting of the speed calculation range according to Embodiment 2;

FIG. 13 is a figure for explaining setting of the speed calculation range according to the regulation speed of road and the speed of own apparatus according to Embodiment 2; and

FIG. 14 is a figure for explaining setting of the speed calculation range according to the regulation speed of road and the speed of own apparatus according to Embodiment 2.

### DETAILED DESCRIPTION OF THE EMBODIMENTS

### 1. Embodiment 1

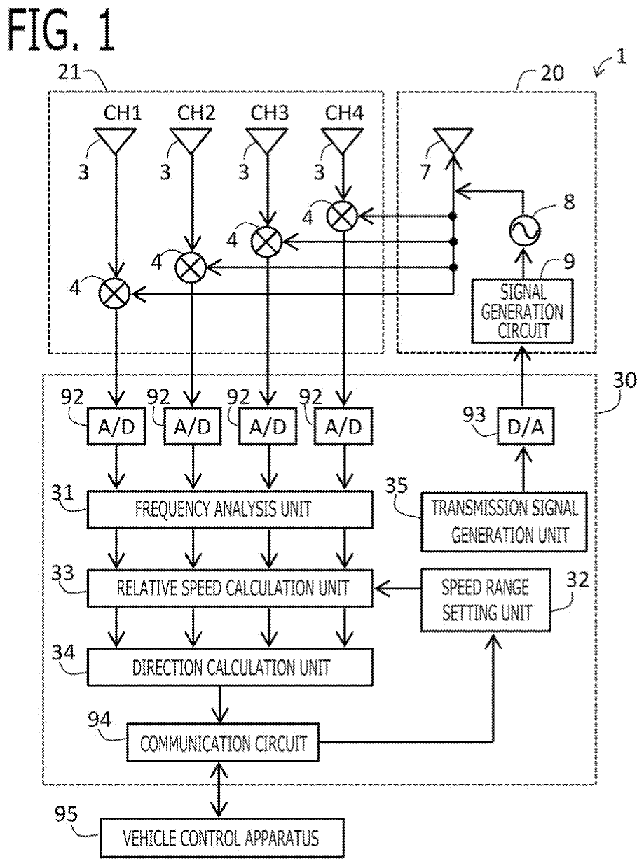

A radar apparatus 1 according to Embodiment 1 will be explained with reference to drawings. FIG. 1 is a figure showing a schematic configuration of the radar apparatus 1. In the present embodiment, the radar apparatus 1 is mounted in a vehicle. The radar apparatus 1 detects position information and speed information on an object, such as, other vehicle, sign, guardrail, and pedestrian, which exist in the periphery of the vehicle. The radar apparatus 1 transmits the detected information on the object, to the vehicle control apparatus 95 and the like which controls the vehicle. The radar apparatus 1 may be mounted in apparatus other than the vehicle (for example, a plane, a monitoring apparatus, and the like).

The radar apparatus 1 is provided with a transmission unit 20 that transmits plural kinds of frequency modulation signals whose detection ranges of relative speed are different with each other, from a transmission antenna; a reception unit 21 that receives the plural kinds of frequency modulation signals reflected by one or a plurality of objects, by a reception antenna, and mixes the transmitted frequency modulation signal and the received frequency modulation signal and generates a beat signal, about each kind of the frequency modulation signal; and a controller 30 that processes the beat signal of each kind of the frequency modulation signal. In the present embodiment, the transmission unit 20 transmits two kinds of frequency modulation signals of a first frequency modulation signal and a second frequency modulation signal.

In the present embodiment, the transmission unit 20 is provided with a transmission antenna 7, an oscillation circuit 8, and a signal generation circuit 9. The reception unit 21 is provided with a plurality of reception antennas 3 (in this example, four of first channel CH1 to fourth channel CH4), and a plurality of mixers 4 (in this example, four) connected to each reception antenna 3. The controller 30 A/D converts a signal outputted from each mixer 4 by A/D converter 92 (in this example, four), and processes the A/D converted digital signal.

The radar apparatus 1 uses FCM (Fast Chirp Modulation) method. A frequency modulation signal ST (hereinafter, referred to also as a transmitting signal ST) which is transmitted by the transmission antenna 7 is a chirp signal ST (hereinafter, referred to also as a transmission chirp signal ST) whose frequency increases or decreases at a prescribed frequency modulation width and a prescribed frequency modulation period Tm. In the transmitting signal ST, a number M of the frequency modulation period Tm that the frequency modulation is performed continuously (hereinafter, referred to as a chirp number M) is set.

Plural kinds of transmitting signals ST are plural kinds of chirp signals that at least the frequency modulation periods Tm are different with each other among kinds. The frequency modulation width and the chirp number are set according to a detection range of distance, a detection resolution of distance, and a detection resolution of relative speed; and may be set different values among kinds of the transmitting signals ST or may be set as the same value.

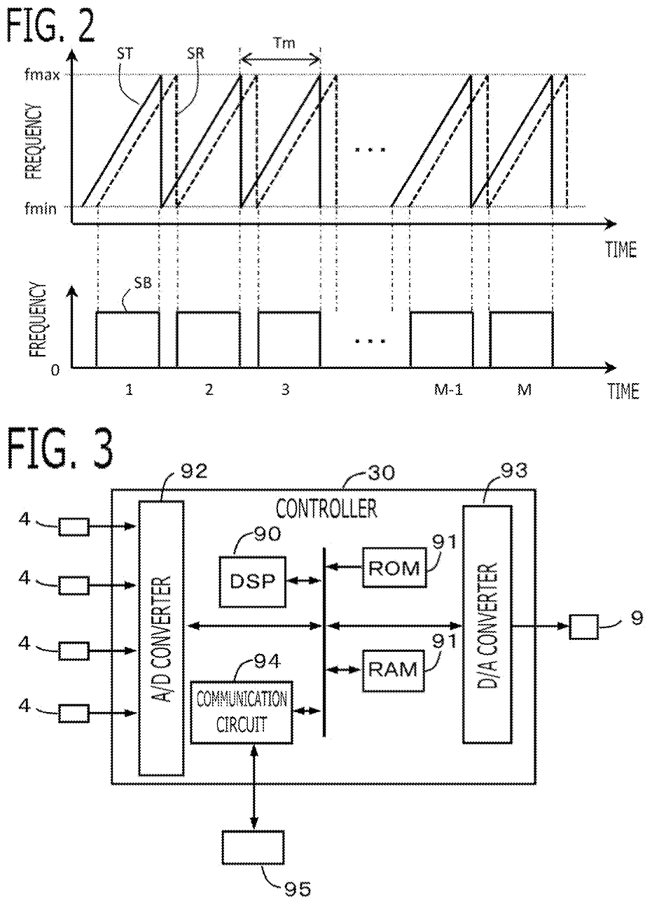

In the present embodiment, as shown in the upper row graph of FIG. 2, the transmission chirp signal ST of each kind is a saw tooth wave that the frequency increases at a constant inclination from the minimum frequencies fmin to the maximum frequency fmax during the frequency modulation period Tm, and after that decreases to the minimum frequencies fmin stepwise. The transmission chirp signal ST of each kind may be a reverse saw tooth wave that the frequency decreases at a constant inclination from the maximum frequency fmax to the minimum frequencies fmin during the frequency modulation period Tm, and after that increases to the maximum frequency fmax stepwise. The frequency modulation width, the frequency modulation period Tm, and the chirp number M are preliminarily set according to the detection range of relative speed and the detection resolution of relative speed of transmitting signal ST of each kind.

The signal generation circuit 9 calculates the frequency of the transmission chirp signal ST at each time point as shown in the upper row graph of FIG. 2, based on the command value of the frequency modulation signal (for example, the frequency modulation width (the minimum frequencies fmin, the maximum frequency fmax), the frequency modulation period Tm, and the chirp number M) transmitted from the controller 30; and transmits an electric signal indicating frequency, to the oscillation circuit 8. The oscillation circuit 8 generates an electric signal for generating a radio wave with the transmitted frequency (for example, sine wave), and transmits it to the transmission antenna 7. The transmission antenna 7 converts the transmitted electric signal into a radio wave, and transmits to space.

In the present embodiment, the transmission unit 20 transmits the transmission signal ST of each kind in order from the transmission antenna 7. Specifically, the transmission unit 20 transmits a first transmission signal which has a first chirp number, a first frequency modulation width, and a first frequency modulation period which are preliminarily set for the first transmitting signal; and after that, transmits a second transmission signal which has a second chirp number, a second frequency modulation width (a second minimum frequency, a second maximum frequency), and a second frequency modulation period which are preliminarily set for the second transmission signal. The transmission unit 20 repeatedly performs transmission of the first transmission signal and the second transmission signal.

Each reception antenna 3 converts a received radio wave (a frequency modulation signal) into an electric signal indicating frequency, and transmits it to each mixer 4. As shown in the lower row graph of FIG. 2, each mixer 4 mixes the transmission signal ST and the received frequency modulation signal SR (hereinafter, referred to as a reception signal SR), and outputs a beat signal SB. The beat signal SB is generated for every frequency modulation period Tm.

Next, the controller 30 will be explained. The controller 30 is provided with processing units of a frequency analysis unit 31, a speed range setting unit 32, a relative speed calculation unit 33, a direction calculation unit 34, a transmission signal generation unit 35, and the like. The respective control units 31 to 35 and the like of the controller 30 are realized by processing circuits included in the controller 30. Specifically, as shown in FIG. 3, the controller 30 is provided with, as processing circuits, an arithmetic processor (computer) 90 such as DSP (Digital Signal Processor), storage apparatuses 91 which exchange data with the arithmetic processor 90, an A/D converter 92 which inputs the beat signal SB into the arithmetic processor 90, a D/A converter 93 which outputs the command value of frequency modulation signal outside from the arithmetic processor 90, a communication circuit 94, and the like.

As the arithmetic processor 90, CPU (Central Processing Unit), ASIC (Application Specific Integrated Circuit), IC (Integrated Circuit), FPGA (Field Programmable Gate Array), various kinds of logical circuits, various kinds of signal processing circuits, and the like may be provided. As the arithmetic processor 90, a plurality of the same type ones or the different type ones may be provided, and each processing may be shared and executed. As the storage apparatuses 91, a RAM (Random Access Memory) which can read data and write data from the arithmetic processor 90, a ROM (Read Only Memory) which can read data from the arithmetic processor 90, and the like are provided. The communication circuit 94 is connected with an external controller such as a vehicle control apparatus 95 through a communication wire and performs cable communication based on a communication protocol such as the CAN (Controller Area Network). The position speed information of the detected object and the like are transmitted to the vehicle control apparatus 95 and the like from the communication circuit 94. The speed information of the own vehicle and the like are transmitted to the communication circuit 94 from the vehicle control apparatus 95 and the like.

Then, the arithmetic processor 90 runs software items (programs) stored in the storage apparatus 91 such as a ROM and collaborates with other hardware devices in the controller 30, such as the storage apparatus 91, the A/D converter 92, the D/A converter 93, and the communication circuit 94, so that the respective functions of the control units 31 to 35 included in the controller 30 are realized. Various kinds of setting data items to be utilized in the control units 31 to 35 are stored, as part of software items (programs), in the storage apparatus 91 such as ROM.

### <Transmission Signal Generation Unit 35>

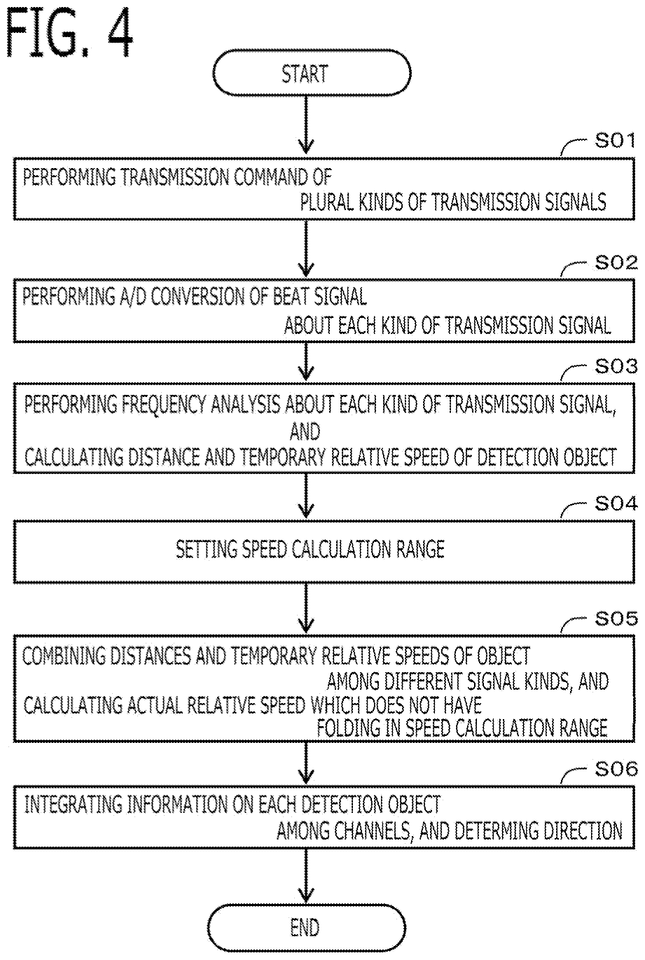

In the step S01 of FIG. 4, the transmission signal generation unit 35 calculates plural kinds of command values of transmission signal whose detection ranges of relative speed are different with each other, and transmits to the transmission unit 20 (the signal generation circuit 9) via the D/A converter 93. In the present embodiment, the transmission signal generation unit 35 repeatedly calculates plural kinds of setting values of transmission signal which are preliminarily set so that the detection ranges of relative speed are different with each other (in this example, the frequency modulation width (the minimum frequencies fmin, the maximum frequency fmax), the frequency modulation period Tm, and the chirp number M) in order, and transmits to the transmission unit 20.

In the present embodiment, as mentioned above, two kinds of transmission signals of the first transmission signal and the second transmission signal are transmitted. The transmission signal generation unit 35 calculates setting values of the first transmission signal which are preliminarily set so as to be a first detection range of relative speed (in this example, the first frequency modulation width, the first frequency modulation period, and the first chirp number), and setting values of the second transmission signal which are preliminarily set so as to be a second detection range of relative speed which is different from the first detection range of relative speed (in this example, the second frequency modulation width, the second frequency modulation period, and the second chirp number).

The first frequency modulation period and the second frequency modulation period are set to mutually different values. The frequency modulation width and the chirp number may be set to mutually different values, or may be set to the same value, between the first transmission signal and the second transmission signal.

### <A/D Conversion>

In the step S02 of FIG. 4, each A/D converter 92 (from CH1 to CH4) samples the beat signal SB outputted from each mixer 4 (from CH1 to CH4) at prescribed frequency, and converts into a digital signal. The beat signal SB converted into the digital signal is stored in the storage apparatus 91, such as RAM.

Processing of the frequency analysis unit 31, the speed range setting unit 32, and the relative speed calculation unit 33 which are explained in the following are executed for every channel; and a distance and an actual relative speed without folding of the detection object are calculated. By integrating signals of plural channels and the like, signals of channels may be processed collectively.

### <Frequency Analysis Unit 31>

In the step S03 of FIG. 4, the frequency analysis unit 31 performs a frequency analysis of the A/D converted beat signal SB about each kind of the frequency modulation signal, and calculates a distance and a relative speed with respect to the radar apparatus 1 about each of the object. In the relative speed obtained by this frequency analysis result, a folding due to the detection range of the relative speed may occur. In the following, this relative speed is referred to as a temporary relative speed.

First, the calculation method of the distance and the temporary relative speed will be explained. Since delay time after transmitting the transmission signal ST until receiving the reception signal SR may increase or decrease in proportion to the distance between the object and the radar apparatus 1, the frequency of the beat signal SB is proportional to the distance between the object and the radar apparatus 1. Accordingly, if frequency analysis, such as fast Fourier transform (FFT: Fast Fourier Transform), is performed to the beat signal SB of each period, a peak will appear at a position of a frequency corresponding to the distance. In the fast Fourier transform, a receiving level and phase information are extracted for each frequency point (hereinafter, referred to also as a distance bin) which is set with a prescribed frequency interval. Accordingly, a peak appears at a frequency point (a distance bin) corresponding to the distance. Therefore, the distance is calculated from the frequency point (the distance bin) where the peak occurred.

Calculation of the temporary relative speed will be explained. In FCM method, when the relative speed occurs between the object and the radar apparatus 1, a phase change according to Doppler frequency appears between the beat signals of each period. Specifically, if the relative speed is 0, since the Doppler component does not occur in the reception signal SR, the phase of the reception signal SR to the transmission signal ST becomes all the same between the beat signals of each period. However, if the relative speed is not 0, the phase of the reception signal SR to the transmission signal ST changes between the beat signals of each period.

This phase information is included in the frequency analysis result of the beat signal of each period. Accordingly, if the frequency analysis results of the beat signals of each period are arranged in time series, and frequency analysis, such as second fast Fourier transform, is performed, a peak appears at a position of Doppler frequency. In the fast Fourier transform, phase information is extracted for each frequency point (hereinafter, referred to also as a relative speed bin) which is set with a prescribed frequency interval according to the detection resolution of the relative speed. Accordingly, a peak appears at a frequency point (a relative speed bin) corresponding to the relative speed. Therefore, the temporary relative speed is obtained from the frequency point (the relative speed bin) where the peak occurred.

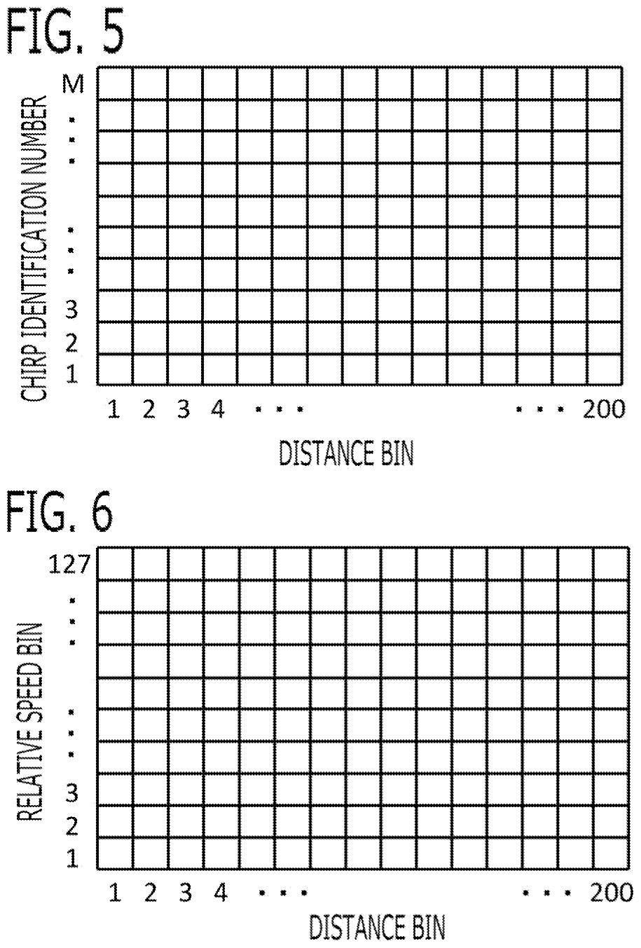

The frequency analysis unit 31 performs fast Fourier transform to the beat signal SB of each period, and obtains a processing result for each distance bin. Since there are the periods of the chirp number, if the processing results are arranged by setting a horizontal axis to the distance bin and setting a vertical axis to a period identification number (a chirp identification number), it becomes matrix form as shown in FIG. 5. Then, the frequency analysis unit 31 performs fast Fourier transform to the processing results in a line of each distance bin, and obtains a processing result for each relative speed bin. If the processing results are arranged by setting a horizontal axis to the distance bin and setting a vertical axis to the relative speed bin, it becomes matrix form as shown in FIG. 6. Then, the frequency analysis unit 31 determines that a point of the distance bin and the relative speed bin that the second processing result becomes large corresponds to the object, and calculates the distance bin and the relative speed bin of the object. If there are a plurality of peaks, a plurality of objects are detected. The frequency analysis unit 31 performs frequency analysis about the beat signal SB of each reception antenna 3, and calculates the distance and the temporary relative speed of the object.

### <Folding of Actual Relative Speed>

In FCM method, frequency analysis of the phase change between the reception signals SR (the beat signals SB) of each period is performed, and the temporary relative speed is detected. According to the sampling theorem, double of the frequency modulation period Tm becomes a lower limit value of the Doppler period (a reciprocal of Doppler frequency) detected without folding, that is, an upper limit value of the relative speed detected without folding. Accordingly, if the Doppler period becomes less than the double of the frequency modulation period Tm, the Doppler frequency is not sampled correctly but is detected as a folding signal (aliasing).

Hereinafter, the relative speed in a direction where the object approaches to the own vehicle (the radar apparatus 1) is explained as a positive value. FIG. 7 shows a figure explaining the folding of the relative speed when the detection range of relative speed is 40 km/h. The horizontal axis shows the actual relative speed without folding, and the vertical axis shows the temporary relative speed detected by the frequency analysis. If the relative speed without folding is from 0 to 40 km/h, the temporary relative speed detected by the frequency analysis also becomes from 0 to 40 km/h. However, if the relative speed without folding become greater than or equal to 40 km/h or less than 0 km/h, the temporary relative speed detected by the frequency analysis repeatedly folds from 0 to 40 km/h. Accordingly, only by the information on the temporary relative speed detected by frequency analysis, the folding number is not obtained and the actual relative speed is not obtained.

The actual relative speed Vr without folding can be calculated by the next equation based on the folding number Na, the detection range of relative speed ΔV, and the temporary relative speed Vf detected by the frequency analysis.

Vr=Vf+Na×ΔV (1)

Herein, folding number Na is either one of integers ( . . . , −2, −1, 0, 1, 2, . . . ). And, the actual relative speed Vr becomes either one of ( . . . , Vf−2×ΔV, Vf−ΔV, Vf, Vf+ΔV, Vf+2×ΔV, . . . ).

Then, by combining the detection results of the temporary relative speeds obtained by plural kinds of transmission signals whose detection ranges of relative speed are different with each other, the actual relative speed Vr without folding can be determined. For example, as shown in the next equation, based on a detection value of temporary relative speed Vf1 by the first transmission signal, and the first detection range of relative speed ΔV1, by increasing the folding number Na from 0 one by one and decreasing the folding number Na from 0 one by one, a plurality of possible first temporary relative speeds ΣVf1 are calculated. Similarly, based on a detection value of temporary relative speed Vf2 by the second transmission signal, and the second detection range of relative speed ΔV2, by increasing the folding number Na from 0 one by one and decreasing the folding number Na from 0 one by one, a plurality of possible second temporary relative speeds ΣVf2 are calculated. Then, a relative speed which coincides between the plurality of possible first temporary relative speeds ΣVf1 and the plurality of possible second temporary relative speeds ΣVf2 is calculated as the actual relative speed Vr without folding.

ΣVf1= . . . ,Vf1−2×ΔV1,Vf1−ΔV2,Vf1,Vf1+ΔV1,Vf1+2×ΔV1, . . .

ΣVf2= . . . ,Vf2−2×ΔV2,Vf2−ΔV2,Vf2,Vf2+ΔV2,Vf2+2×ΔV2, . . .

Vr=ΣVf1∩ΣVf2 (2)

For example, in a case where ΔV1=40, Vf1=0, ΔV2=48, Vf2=32, and a range for calculating the actual relative speed Vr is −150 to 150, as shown in the next equation, 80 become the same between ΣVf1 and ΣVf2, and it is calculated as the actual relative speed Vr without folding.

ΣVf1=−120,−80,−40,0,40,80,120

ΣVf2=−112,−64,−16,32,80,128

Vr=80 (3)

### <Folding of Actual Relative Speed Vr>

However, if the calculation range of the relative speed Vr of the object detected is wide, a plurality of relative speeds which coincide between ΣVf1 and ΣVf2 occur. For example, in a case where ΔV1=40, Vf1=30, ΔV2=48, and Vf2=14, as shown in the next equation, 110 and −130 become the same between ΣVf1 and ΣVf2, and it cannot be determined which one is the right actual relative speed Vr.

ΣVf1=−130,−90,−50,−10,30,70,110,150

ΣVf2=−130,−82,−34,14,62,110

Vr=−130,110 (4)

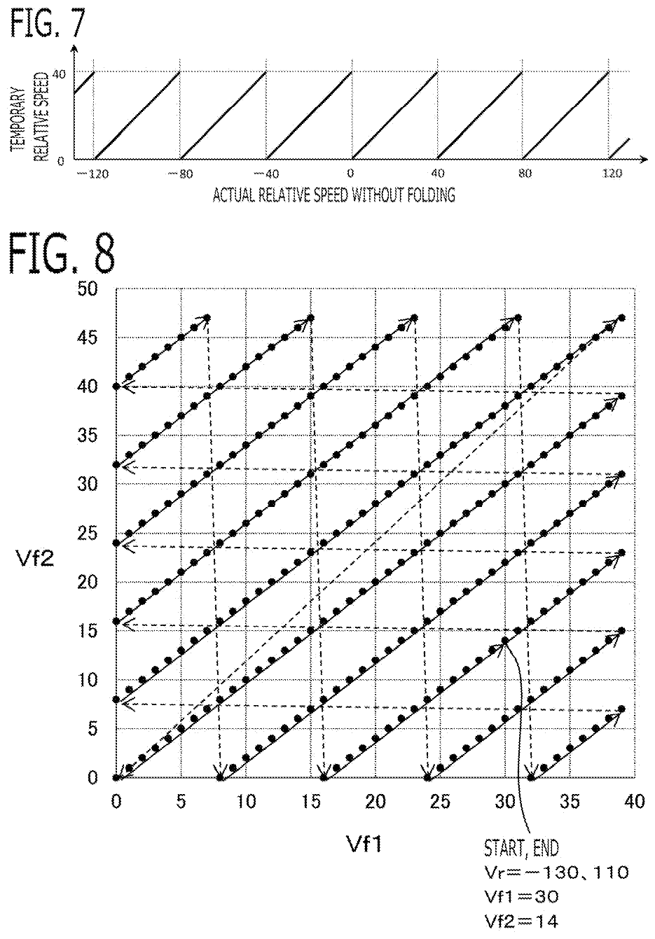

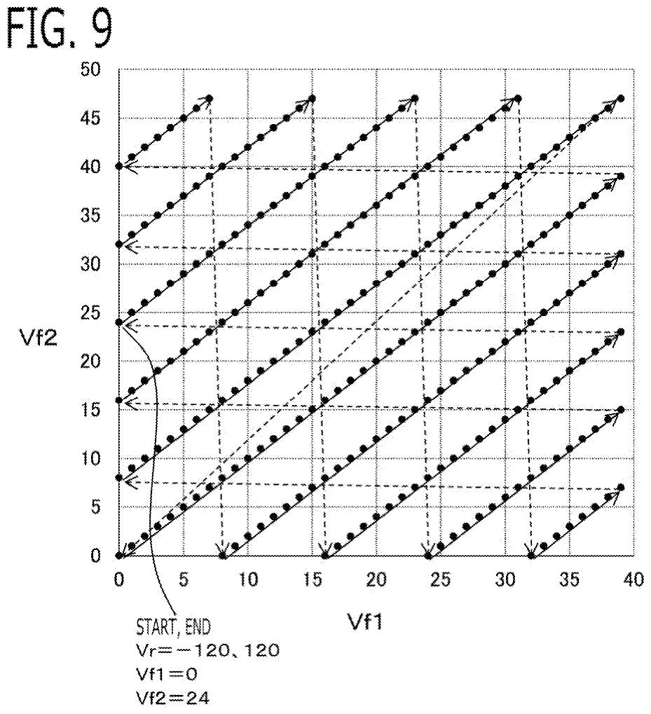

FIG. 8 shows a relationship between the first temporary relative speed Vf1 and the second temporary relative speed Vf2 when changing the actual relative speed Vr from −130 to 110 one by one. FIG. 9 shows a relationship between the first temporary relative speed Vf1 and the second temporary relative speed Vf2 when changing the actual relative speed Vr from −120 to 120 one by one. According to these figures, if the change width of the actual relative speed Vr becomes 240, the combination of the first temporary relative speed Vf1 and the second temporary relative speed Vf2 make a round. Accordingly, if the change width of the actual relative speed becomes greater than or equal to 240, two or more of the actual relative speeds Vr corresponding to the combination of the same first and second temporary relative speed Vf1, Vf2 occur, and the actual relative speed Vr is not decided uniquely. That is to say, folding occurs also in the actual relative speed Vr. This change width of the actual relative speed that the folding occurs, becomes a least common multiple Lcm between the first detection range of relative speed ΔV1 and the second detection range of relative speed ΔV2. In the example of FIG. 8 and FIG. 9, the speed width ΔVr which makes a round becomes 240 which is the least common multiple between ΔV1=40 and ΔV2=48.

In a case where ΔV1=41 and ΔV2=48, the least common multiple becomes 1968. However, whenever the actual relative speed Vr changes by 240, the first temporary relative speed Vf1 and the second temporary relative speed Vf2 which become closer than the detection resolution occur. Accordingly, a plurality of actual relative speeds which are different 240 by 240 with respect to a certain value of the first temporary relative speed Vf1 and the second temporary relative speed Vf2 correspond to the right actual relative speed. The actual relative speed cannot be decided uniquely. Accordingly, it is necessary to set the calculation range of the actual relative speed Vr to less than the speed width that the actual relative speed can be calculated uniquely.

### <Speed Range Setting Unit 32>

In the step S04 of FIG. 4, the speed range setting unit 32 sets a speed calculation range. The speed range setting unit 32 sets a speed width ΔVr of the speed calculation range to less than a speed width that the actual relative speed can be calculated uniquely.

According to this configuration, since the speed calculation range is set to less than a speed width that the actual relative speed can be calculated uniquely, two or more of the actual relative speeds Vr corresponding to combination can be prevented from being calculated, and the actual relative speed Vr can be calculated uniquely.

The speed range setting unit 32 sets the speed width ΔVr of the speed calculation range to less than a width of the actual relative speed that a value closer than a determination speed width occurs again in a value of the temporary relative speed of each kind of the transmission signal.

According to this configuration, a round of combination that a value close to a value of the temporary relative speed of each kind of the transmission signals occurs again can be prevented from occurring, and the actual relative speed Vr can be calculated uniquely. Herein, the determination speed width may be the same value as the determination speed width which is used in the relative speed calculation unit 33 described below, or may be a different value.

In a case where ΔV1=41 and ΔV2=48, the least common multiple is 1968, but the speed width that the actual relative speed can be calculated uniquely is set to 240 which is smaller than 1968. That is to say, the speed width that the actual relative speed can be calculated uniquely is a value smaller than the least common multiple of the detection ranges of relative speed of the plural kinds of transmission signals.

According to this configuration, without depending on the least common multiple, the speed width that the actual relative speed can be calculated uniquely can be set appropriately.

On the other hand, in a case where ΔV1=40 and ΔV2=48, the least common multiple is 240, and the speed width that the actual relative speed can be calculated uniquely is set to 240. That is to say, the speed width that the actual relative speed can be calculated uniquely becomes the least common multiple of the detection ranges of relative speed of the plural kinds of transmission signals.

The speed range setting unit 32 changes the speed calculation range to an increase side or a decrease side of the relative speed, according to the speed of own apparatus Vs.

A range where the relative speed of the object detected by the radar apparatus 1 can take, and a range of the relative speed where detection is necessary change according to the speed of own apparatus Vs. As described above, since the speed calculation range is changed according to the speed of own apparatus Vs, the speed calculation range can be made appropriate according to the speed of own apparatus Vs.

In the present embodiment, as mentioned above, since the first detection range of relative speed ΔV1 is 40, the second detection range of relative speed ΔV2 is 48 and the speed width that the actual relative speed Vr can be calculated uniquely is 240, the speed width of speed calculation range ΔVr is set to a value less than 240 (for example, 239).

The speed range setting unit 32 sets an upper limit value Vrmax of the speed calculation range, and a lower limit value Vrmin of the speed calculation range, and sets a speed width ΔVr between the upper limit value Vrmax and the lower limit value Vrmin to less than speed width that the actual relative speed can be calculated uniquely. The speed range setting unit 32 changes the upper limit value Vrmax and the lower limit value Vrmin according to the speed of own apparatus Vs.

In the present embodiment, the speed range setting unit 32 acquires speed information of the vehicle in which the radar apparatus 1 is mounted, from the vehicle control apparatus 95, as the speed of own apparatus Vs. Alternatively, the radar apparatus 1 is provided with an acceleration sensor, and the speed of own apparatus Vs may be calculated by integrating an acceleration detected by the acceleration sensor.

The speed range setting unit 32 changes the speed calculation range to the increase side of the relative speed, as the speed of own apparatus Vs increases. The relative speed in the direction where the object approaches to the own apparatus is defined as a positive value. As the speed of own apparatus Vs increases, the relative speed of the object which is required to be detected, such as a static object, a low speed object, an oncoming vehicle, a vehicle traveling in the same direction and slower than the own vehicle, increases. The static object includes a stop vehicle, a roadside object, and the like. The low speed object includes a pedestrian, a bicycle, and the like. Accordingly, as the speed of own apparatus Vs increases, the speed calculation range is changed to the increase side, and the relative speed of the object which is required to be detected can be detected with good accuracy.

The speed range setting unit 32 sets the speed calculation range so as to include 0. The object whose relative speed is 0 includes a front vehicle which travels in the same direction at the same speed as the own vehicle. For safe traveling of the own vehicle, it is necessary to detect the relative speed of the object whose relative speed is close to 0. Accordingly, by setting the speed calculation range so as to include 0, the relative speed of the front vehicle which travels in the same direction at the speed close to the own vehicle can be detected, and it can be used for traveling of the own vehicle.

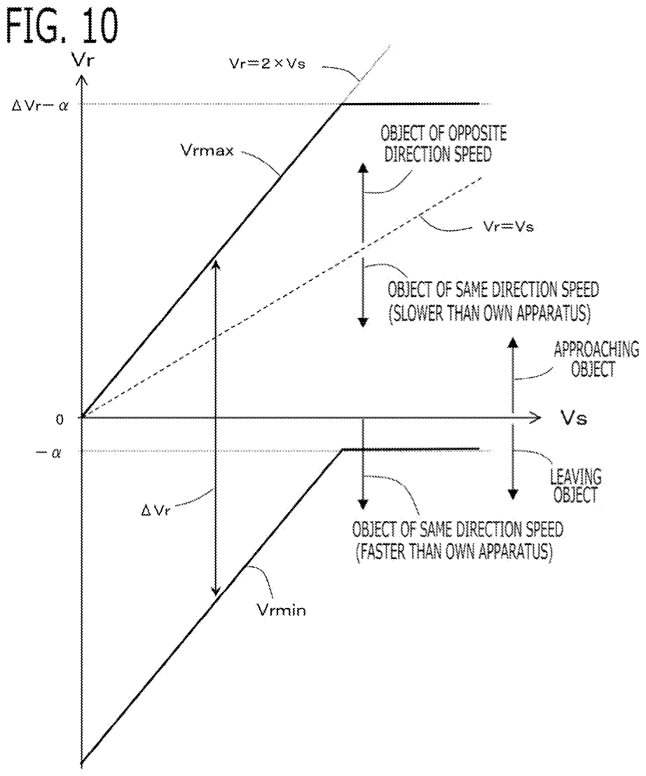

For example, as shown in the next equations and FIG. 10, the speed range setting unit 32 sets any smaller one of a value obtained by multiplying a coefficient larger than one (in this example, 2) to the speed of own apparatus Vs, and a value obtained by subtracting an absolute value a of a preliminarily set maximum lower limit value from the speed width ΔVr, as the upper limit value Vrmax of the speed calculation range, A value obtained by subtracting the speed width ΔVr from the upper limit value Vrmax is set as the lower limit value Vrmin of the speed calculation range. Herein, MIN (A, B) is a function which outputs any smaller one of A and B.

ΔVr<Lcm

Vrmax=MIN(Vs×2,ΔVr−a)

Vrmin=Vrmax−ΔVr (5)

According to this configuration, when the speed of own apparatus Vs is low, since a value obtained by multiplying the coefficient larger than one to the speed of own apparatus Vs is set as the upper limit value Vrmax, the relative speed of the static object, the low speed object, and the oncoming vehicle can be detected. The static object includes a stop vehicle, a roadside object, and the like. The low speed object includes a pedestrian, a bicycle, and the like.

If the coefficient is set to a value greater than or equal to two, the relative speed of the oncoming vehicle which travels in the opposite lane at the same speed as the own vehicle or at a speed higher than the own vehicle can be detected. Since it can be assumed that the speed of the oncoming vehicle which travels in the opposite lane is close to the speed Vs of the own vehicle usually, the upper limit value Vrmax is set based on the speed Vs of the own vehicle, and the relative speed of the oncoming vehicle can be detected.

Even when the speed Vs of the own vehicle becomes high, since the lower limit value Vrmin is set to −α and does not become larger than 0, the relative speed of the front vehicle which travels in the same direction at the speed close to the own vehicle can be detected, and it can be used for traveling of the own vehicle.

### <Relative Speed Calculation Unit 33>

In the step S05 of FIG. 4, the relative speed calculation unit 33 combines the distance and the temporary relative speed of the object among different kinds of the frequency modulation signals, respectively, and calculates an actual relative speed Vr which does not have folding due to the detection range of relative speed, within the speed calculation range which is set by the speed range setting unit 32, about each object.

When a plurality of objects are detected, the relative speed calculation unit 33 determines a combination of the objects of respective kinds of the transmission signals in which the distances of the objects detected by respective kinds of the transmission signals correspond with each other. For example, the relative speed calculation unit 33 determines a combination of the object of the first transmission signal and the object of the second transmission signal in which the distance of the object detected by the first transmission signal and the distance of the object detected by the second transmission signal become within a preliminarily set determination distance range.

Then, as shown in the equation (1) and the equation (2), about each combination in which the distances of the objects correspond with each other, the relative speed calculation unit 33 determines whether the temporary relative speeds which become closer than the determination speed width with each other exists or not, between a plurality of temporary relative speeds of the first transmission signal which are calculated by increasing and decreasing the folding number from 0 one by one, and a plurality of temporary relative speeds of the second transmission signal which are calculated by increasing and decreasing the folding number from 0 one by one, within the speed calculation range. Then, when determining that the temporary relative speeds which become closer than the determination speed width with each other exists, the relative speed calculation unit 33 calculates the temporary relative speed which become closer than the determination speed width with each other, as the actual relative speed without folding. The determination speed width is set considering the detection resolution of speed and the detection variation width.

For example, in a case where the upper limit value Vrmax of the speed calculation range is set to 200 km/h and the lower limit value Vrmin of the speed calculation range is set to −39 km/h, the first temporary relative speeds ΣVf1 and the second temporary relative speeds ΣVf2 are calculated within a range from the upper limit value Vrmax to the lower limit value Vrmin, as shown in the next equation, in the example of the equation (4). Accordingly, folding does not occur in the actual relative speed Vr, and it is calculated uniquely.

Vrmax=200, Vrmin=−39

Vrmin<=ΣVf1<=Vrmax

Vrmin<=ΣVf2<=Vrmax

ΣVf1=−10,30,70,110,150,190

ΣVf2=−34,14,62,110,158

Vr=110 (6)

### <Direction Calculation Unit 34>

In the step S06 of FIG. 4, the direction calculation unit 34 integrates the distances and the actual relative speeds without folding of one or a plurality of the detection objects which are calculated for each channel, among channels, and determines a direction of each detection object. The direction calculation unit 34 integrates the detection objects whose distances and actual relative speeds correspond, among channels, and calculates the direction. Then, information on the distance, the actual relative speed without folding, and the direction of each detection object is transmitted to the vehicle control apparatus 95 and the like via the communication circuit 94.

### 2. Embodiment 2

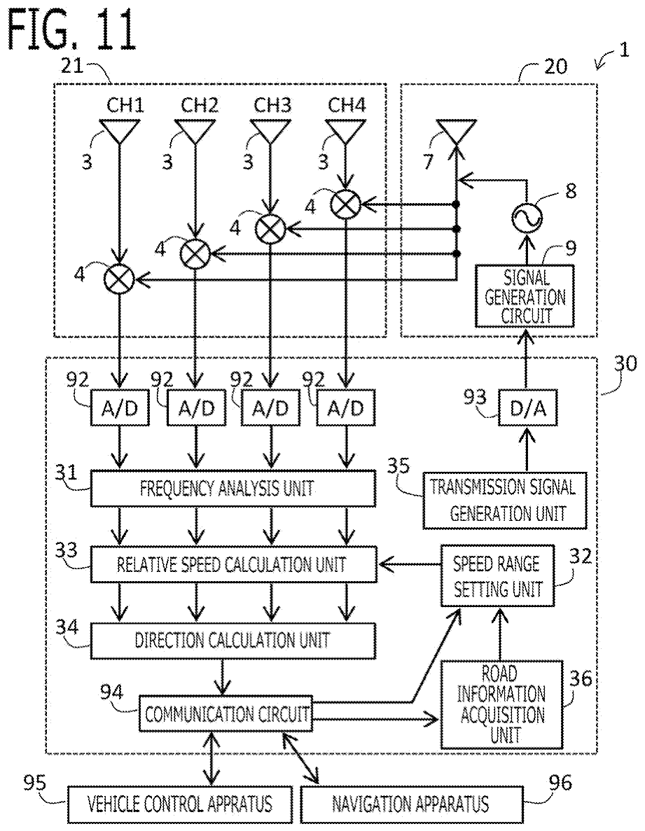

Next, the radar apparatus 1 according to Embodiment 2 will be explained. The explanation for constituent parts the same as those in Embodiment 1 will be omitted. The basic configuration of the radar apparatus 1 according to the present embodiment is the same as that of Embodiment 1. Embodiment 2 is different from Embodiment 1 in that the speed calculation range is set considering the regulation speed Vlmt of road. FIG. 11 is a figure showing the schematic configuration of the radar apparatus 1 according to the present embodiment.

Similarly to Embodiment 1, the speed range setting unit 32 sets the speed width ΔVr of the speed calculation range to less than a speed width that the actual relative speed can be calculated uniquely. Then, the speed range setting unit 32 changes the speed calculation range to an increase side or a decrease side of the relative speed, according to the speed of own apparatus Vs.

Similarly to Embodiment 1, the speed range setting unit 32 changes the speed calculation range to the increase side of the relative speed, as the speed of own apparatus Vs increases. The speed range setting unit 32 sets the speed calculation range so as to include 0.

Unlike Embodiment 1, the controller 30 is provided with a road information acquisition unit 36. The road information acquisition unit 36 acquires information on a regulation speed Vlmt of a road where the own apparatus mounted in the vehicle is located. The communication circuit 94 communicates with a navigation apparatus 96. The navigation apparatus 96 is an apparatus which performs a route guide of the own vehicle. The navigation apparatus 96 has road map data, and has the information on the regulation speed Vlmt of the road where the own vehicle is located. The regulation speed Vlmt is the maximum speed of road determined by law, for example, is set for every classification of road. Then, the road information acquisition unit 36 acquires the information on the regulation speed Vlmt of road from the navigation apparatus 96 via the communication circuit 94. The road information acquisition unit 36 may be unable to acquire the information on the regulation speed Vlmt of road for some reason, such as because the regulation speed Vlmt is not set for the road.

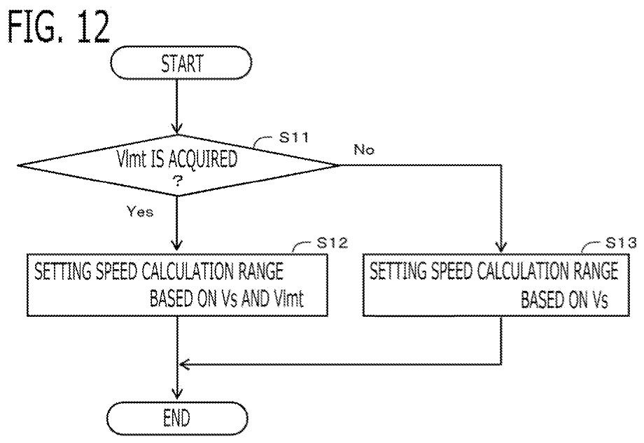

FIG. 12 shows the flowchart of processing of the speed range setting unit 32 according to the present embodiment. In the step S11, the speed range setting unit 32 determines whether or not the information on the regulation speed Vlmt of road is acquired by the road information acquisition unit 36. When acquired, it advances to the step S12, or when not acquired, it advances to the step S13.

When the information on the regulation speed Vlmt of road is not acquired, in the step S13, similarly to Embodiment 1, the speed range setting unit 32 changes the speed calculation range to an increase side or a decrease side of the relative speed, according to the speed of own apparatus Vs. For example, the speed range setting unit 32 sets the speed calculation range as explained using the equation (5).

On the other hand, when the information on the regulation speed Vlmt of road is acquired, in the step S12, the speed range setting unit 32 sets the speed calculation range so as to include a value obtained by adding the speed of own apparatus Vs to a value obtained by multiplying a coefficient greater than or equal to one (in this example, one) to the regulation speed Vlmt of road.

According to this configuration, the relative speed of the oncoming vehicle which travels in the opposite lane according to the regulation speed Vlmt can be detected. Accordingly, based on the acquired regulation speed Vlmt, the speed calculation range that the relative speed of the oncoming vehicle can be detected can be set with good accuracy.

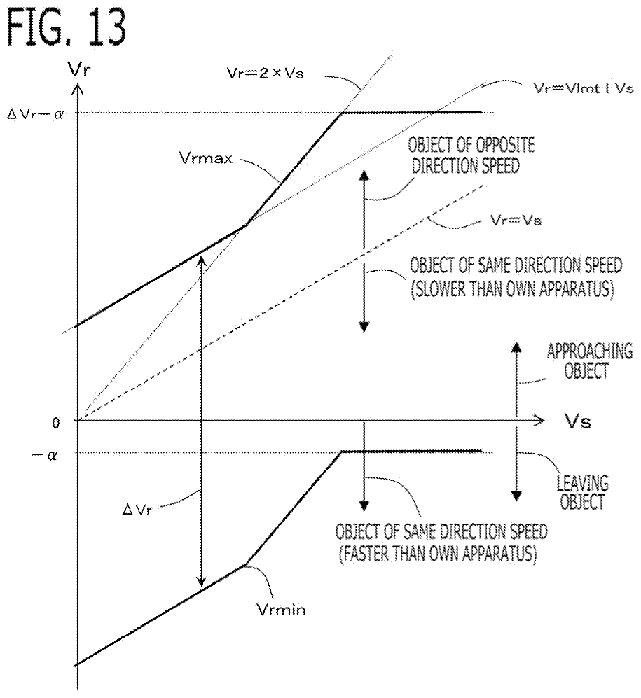

For example, as shown in the next equation and FIG. 13, the speed range setting unit 32 select any larger one of a value obtained by adding the speed of own apparatus Vs to a value obtained by multiplying a coefficients greater than or equal to one (in this example, one) to the regulation speed Vlmt of road, and a value obtained by multiplying a coefficient greater than or equal to two (in this example, two) to the speed of own apparatus Vs; sets any smaller one of the selected value, and a value obtained by subtracting an absolute value a of the preliminarily set maximum lower limit value from the speed width ΔVr, as the upper limit value Vrmax of the speed calculation range; and sets a value obtained by subtracting the speed width ΔVr from the upper limit value Vrmax to the lower limit value Vrmin of the speed calculation range. Herein, MAX (A, B) is a function which outputs any larger one of A and B.

ΔVr<Lcm

Vrmax=MIN(MAX(Vlmt+Vs,Vs×2),ΔVr−α)

Vrmin=Vrmax−ΔVr (7)

According to this configuration, when the speed Vs of the own vehicle is lower than the regulation speed Vlmt, Vlmt+Vs is selected, and the relative speed of the oncoming vehicle which travels in the opposite lane according to the regulation speed Vlmt can be detected. On the other hand, when the speed Vs of the own vehicle is higher than the regulation speed Vlmt, Vs×2 is selected, and the relative speed of the oncoming vehicle which travels in the opposite lane at the speed higher than or equal to the speed of the own vehicle can be detected. Therefore, in either case, the relative speed of the oncoming vehicle which travels in the opposite lane at the regulation speed Vlmt can be detected.

Since a value larger than the speed of own apparatus Vs is set as the upper limit value Vrmax, the relative speed of the static object, the low speed object, and the oncoming vehicle can be detected. The static object includes a stop vehicle, a roadside object, and the like. The low speed object includes a pedestrian, a bicycle, and the like.

Even when the speed Vs of the own vehicle becomes high, since the lower limit value Vrmin is set to −α and does not become larger than 0, the relative speed of the front vehicle which travels in the same direction at the speed close to the own vehicle can be detected, and it can be used for traveling of the own vehicle.

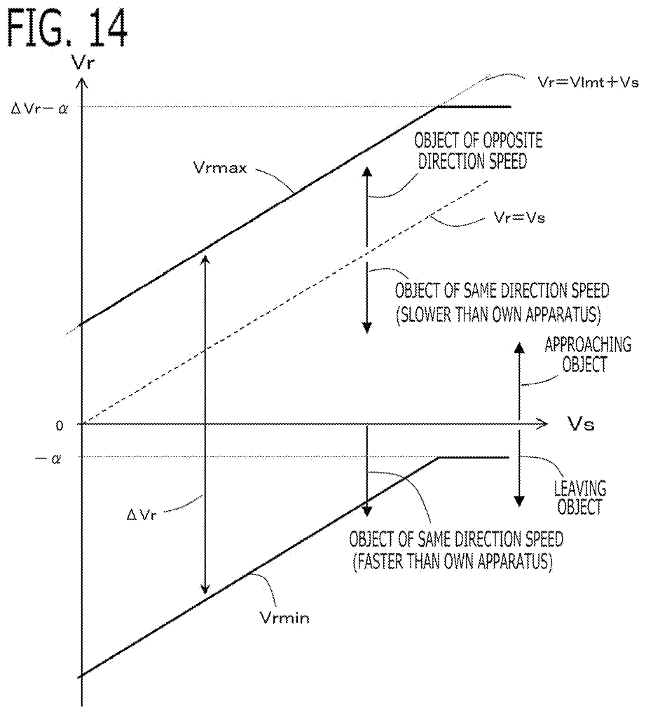

Alternatively, as shown in the next equations and FIG. 14, the speed range setting unit 32 may set any smaller one of a value obtained by adding the speed of own apparatus Vs to a value obtained by multiplying a coefficient greater than or equal to one (in this example, one) to the regulation speed Vlmt of road, and a value obtained by subtracting the absolute value a of the preliminarily set maximum lower limit value from the speed width ΔVr, as the upper limit value Vrmax of the speed calculation range; and may set a value obtained by subtracting the speed width ΔVr from the upper limit value Vrmax, as the lower limit value Vrmin of the speed calculation range.

ΔVr<Lcm

Vrmax=MIN(Vlmt+Vs,ΔVr−α)

Vrmin=Vrmax−ΔVr (8)

According to this configuration, the relative speed of the oncoming vehicle which travels in the opposite lane according to the regulation speed Vlmt can be detected.

Although the present disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations to one or more of the embodiments. It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### REFERENCE SIGNS LIST

1: Radar Apparatus, 3: Reception Antenna, 7: Transmission Antenna, 20: Transmission Unit, 21: Reception Unit, 31: Frequency Analysis Unit, 32: Speed Range Setting Unit, 33: Relative Speed Calculation Unit, 34: Direction Calculation Unit, 35: Transmission Signal Generation Unit, 36: Road Information Acquisition Unit, SR: Received frequency modulation signal (reception signal), ST: Transmitted frequency modulation signal (transmission signal), Vlmt: Regulation speed of road, Vr: Actual relative speed, Vrmax: Upper limit value of speed calculation range, Vrmin: Lower limit value of speed calculation range, Vs: Speed of own apparatus

1. A radar apparatus comprising at least one processor configured to implement:
a transmitter that transmits plural kinds of frequency modulation signals whose detection ranges of relative speed are different with each other, from a transmission antenna;
a receiver that receives the plural kinds of frequency modulation signals reflected by one or a plurality of objects, by a reception antenna, and mixes the transmitted frequency modulation signal and the received frequency modulation signal and generates a beat signal, about each kind of the frequency modulation signal;
a frequency analyzer that performs a frequency analysis of the beat signal about each kind of the frequency modulation signal, and calculates a distance and a temporary relative speed with respect to an own apparatus about each of the object;
a speed range setter that sets a speed calculation range; and
a relative speed calculator that combines the distance and the temporary relative speed of the object among different kinds of the frequency modulation signals, respectively, and calculates an actual relative speed which does not have folding due to a detection range of the relative speed, within the speed calculation range, about the each object,
wherein the speed range setter sets a speed width of the speed calculation range to less than a speed width that the actual relative speed can be calculated uniquely.

2. The radar apparatus according to claim 1,
wherein the speed range setter changes the speed calculation range to an increase side or a decrease side of relative speed, according to a speed of own apparatus.

3. The radar apparatus according to claim 1,
wherein the speed range setter defines a relative speed in a direction where the object approaches to the own apparatus, as a positive value, and changes the speed calculation range to an increase side of relative speed, as a speed of own apparatus increases.

4. The radar apparatus according to claim 1,
wherein the speed range setter sets the speed calculation range so as to include 0.

5. The radar apparatus according to claim 1,
wherein the speed range setter defines a relative speed in a direction where the object approaches to the own apparatus, as a positive value;
sets any smaller one of a value obtained by multiplying a coefficient larger than one to a speed of own apparatus, and a value obtained by subtracting an absolute value of a preliminarily set maximum lower limit value from the speed width, as an upper limit value of the speed calculation range; and
sets a value obtained by subtracting the speed width from the upper limit value, as a lower limit value of the speed calculation range.

6. The radar apparatus according to claim 5,
wherein the coefficient is set to a value greater than or equal to two.

7. The radar apparatus according to claim 1, further comprising
a road information acquisitor that acquires information on a regulation speed of road where the own apparatus mounted in a vehicle locates,
wherein the speed range setter defines a relative speed in a direction where the object approaches to the own apparatus, as a positive value; and
sets the speed calculation range so as to include a value obtained by adding a speed of own apparatus to a value obtained by multiplying a coefficient greater than or equal to one to the regulation speed of road.

8. The radar apparatus according to claim 1,
wherein the speed range setter sets any smaller one of a value obtained by adding a speed of own apparatus to a value obtained by multiplying a coefficient greater than or equal to one to a regulation speed of road, and a value obtained by subtracting an absolute value of a preliminarily set maximum lower limit value from the speed width, as an upper limit value of the speed calculation range; and
sets a value obtained by subtracting the speed width from the upper limit value, as a lower limit value of the speed calculation range.

9. The radar apparatus according to claim 1,
wherein the speed range setter selects any larger one of a value obtained by adding a speed of own apparatus to a value obtained by multiplying a coefficient greater than or equal to one, to a regulation speed of road, and a value obtained by multiplying a coefficient greater than or equal to two to the speed of own apparatus;
sets any smaller one of a selected value, and a value obtained by subtracting an absolute value of a preliminarily set maximum lower limit value from the speed width, as an upper limit value of the speed calculation range; and
sets a value obtained by subtracting the speed width from the upper limit value, as a lower limit value of the speed calculation range.

10. The radar apparatus according to claim 1,
wherein the speed width that the actual relative speed can be calculated uniquely is a width of the actual relative speed that a value closer than a determination speed width occurs again in a value of the temporary relative speed of each kind of the frequency modulation signal.

11. The radar apparatus according to claim 1,
wherein the speed width that the actual relative speed can be calculated uniquely is a value smaller than a least common multiple of the detection ranges of relative speed of the plural kinds of frequency modulation signals.
